(19) United States
(12) Patent Application Publication
(10) Pub. No.: US 2005/0060298 A1
(43) Pub. Date: Mar. 17, 2005

(54) Method and arrangement of user-modified variables in a presentation list

(75) Inventors: Ciprian Agapi, Lake Worth, FL (US); Felipe Gomez, Weston, FL (US); James R. Lewis, Delray Beach, FL (US); Vanessa V. Michelini, Boca Raton, FL (US)

Correspondence Address: AKERMAN SENTERFITT, P. O. BOX 3188, WEST PALM BEACH, FL, 33402-3188, US

(73) Assignee: International Business Machines Corporation, Armonk, NY (US)

(21) Appl. No.: 10/664,293

(22) Filed: Sep. 17, 2003

(51) Int. Cl. G06F 17/30

(52) U.S. Cl. 707/3; 707/4; 707/5

(57) ABSTRACT

A method (10) for arranging user-modified variable names in a presentation list such as a drop-down list can include the steps of receiving (12) a system request to display the variables in the drop-down list, and sorting (14) the variables by giving user named variables greater priority over system named variables and then sorting by a second criteria. The method can further include the step of displaying (16) the variables when a user selects the variables using a drop-down control.

### BACKGROUND OF THE INVENTION

1. Technical Field

This invention relates to the field of user interfaces and more particularly to the presentation of lists from which users will make a selection, such as drop down list and list boxes.

2. Description of the Related Art

A common method for the selection of an item in a graphical user interface (GUI) is a presentation list such as a drop-down list. The default arrangement of items in such as list is typically alphabetical. An alphabetical organization is optimal for some purposes, but not all. One situation in which an alphabetical arrangement is suboptimal is the presentation of variables in a callflow development graphical user interface (GUI), given that users can rename automatically generated variables. In such scenario, an alphabetical arrangement can be cumbersome and less than ideal.

Although there are numerous systems or methods using alphabetical or chronological arrangements, none are ideally suited where a user can rename variables or create user-named variables. Thus, a need exists for a system and method that can overcome the detriments described above.

### SUMMARY OF THE INVENTION

Embodiments in accordance with the invention can enable callflow designers to work more efficiently with lists of variables in a graphical callflow builder, particularly where users can create their own variable names. In such a situation, it is better to place the user created variables at the top of the list because they are the variables that are most likely to be selected by a callflow designer. Each variable in the list can have an attribute that indicates whether the variable has an automatically generated or user generated name. The variable list is sorted first on this attribute, then on a secondary attribute such as position in an alphabetical list or generation time of the name (in a preferred embodiment, the user can select in a Preferences dialog the preferred secondary attribute). Note that this is only one way to implement the invention and it should be understood under the claims herein that any known method of achieving this front-of-screen characteristic in a presentation list is contemplated.

In a first aspect of the invention, a method for arranging user-modified variable names in a presentation list can include the steps of receiving a system request to display the variables in the presentation list, and sorting the variables by giving user-named variables greater priority over system-named variables and then sorting by a second criteria. The method can further include the step of displaying the variables when a user selects the variables using a drop-down control for example.

In a second aspect of the invention, a system for arranging variables in a presentation list can include a memory and a processor programmed to receive a system request to display the variables in the presentation list and to sort the variables by giving user named variables greater priority over system named variables and then sorting by a second criteria.

In a third aspect of the invention, a computer program has a plurality of code sections executable by a machine for causing the machine to perform certain steps as described in the method and systems above.

### BRIEF DESCRIPTION OF THE DRAWINGS

There are shown in the drawings embodiments which are presently preferred, it being understood, however, that the invention is not limited to the precise arrangements and instrumentalities shown.

FIG. 1 is a flow diagram illustrating a method or arranging user generated and built-in criteria accordance with the present invention.

FIG. 2 is an exemplary instantiation of a callflow GUI with system and user-generated labels for callflow elements and illustrating an associated variable presentation list in accordance with the present invention.

### DETAILED DESCRIPTION OF THE INVENTION

Embodiments in accordance with the invention can provide a solution for optimally arranging variables in a presentation list where each variable name in the list is sorted first based on whether the variable name is renamed or created by the user or is system generated, then by a secondary attribute such as position in an alphabetical list. Using this list strategy for variables, a callflow designer will be able to select variables faster, and with better accuracy.

For example, imagine a graphical callflow development system for which each element in the callflow receives an automatically generated label (for example, FOO010). The value of the variable created during that step of the callflow (if any) would be something like FOO010. An alphabetical list of these kinds of variables would look like:
FOOO10
FOOO20
FOOO30
FOOO40
FOOO50

These labels (and corresponding variable names) are not especially meaningful to a designer working with the variables. If the system permits designers to change variable names, a designer would very likely change the names of the key elements that he or she planned to use at later stages of the callflow. Suppose FOOO10 is the step for setting a reminder time, and the designer has renamed the label to Time. Further suppose that the designer, in a later step of the process, is feeding that time back in a system message (You have set a reminder for <Time> tomorrow. Is that correct?). The alphabetical list of variables would look like:
FOOO20
FOOO30
FOOO40
FOOO50
Time

In this hypothetical situation, the only variable that the designer cares enough about to rename is at the bottom of the list of variables. If the system ‘knew’ that this was a user-defined variable name and used that information when creating the variable order, putting user-defined names at the top of the list, the list would look like:
Time
FOOO20
FOOO30
FOOO40
FOOO50

This would make it much easier to work with the variables in this type of system, especially as the number of automatically generated variables becomes larger.

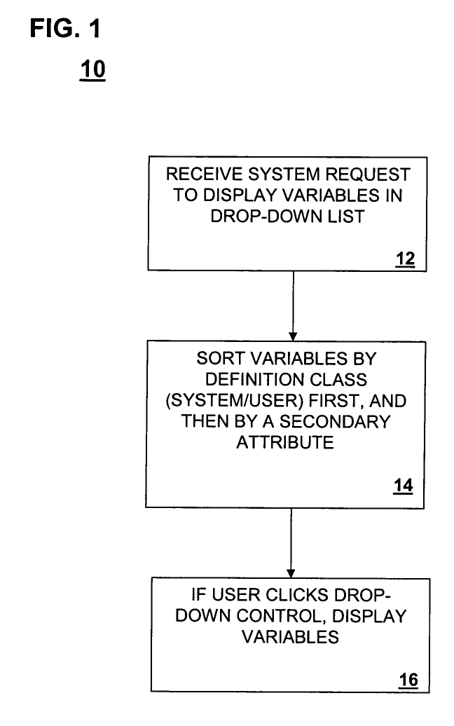

Referring to FIG. 1, a high-level flowchart of a method 10 of optimally arranging variables or variable names in a presentation list such as a drop-down list in accordance with the present invention is shown. The method 10 can include the step of receiving a system request to display variables in a presentation list at step 12. At step 14, the variables can be sorted by user-defined class versus system-defined class first and then by other criteria such as a secondary attribute such as alphabetical order or chronological order. Once a user clicks a drop-down control, the variables can be displayed at step 16 in an order that distinguishes between user defined and system defined classes. The distinction can be achieved in any number of ways including, for example, labeling or by having different types of text formatting (such as italics, color, or bolding).

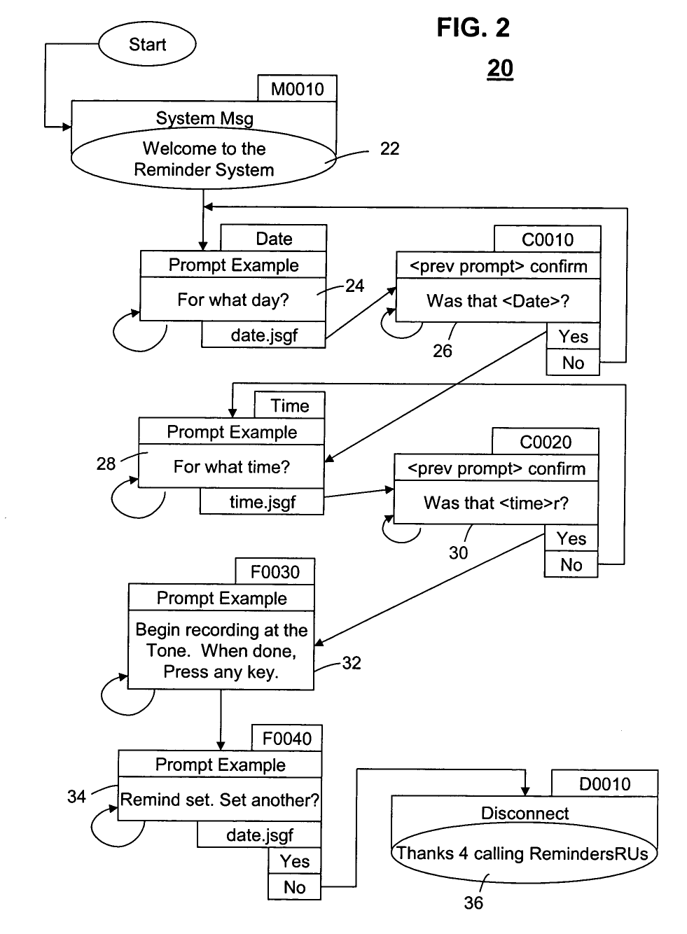

Referring to FIG. 2, a possible instantiation of a callflow GUI with system- and user-generated labels for callflow elements, and a depiction of the associated variable presentation list is shown in accordance with the present invention. In particular, the callflow GUI 20 illustrates a reminder system where callflow element 22 welcomes the user to the system. Callflow element 24 determines a particular date using user defined variable “Date” or date.jsgf. Callflow element 26 confirms an entry for the date. Callflow element 28 determines a time using user defined variable “time” or time.jsgf. Callflow element 30 then confirms the entry from the time. Callflow element 32 then prompts the user to record at the tone and callflow element 34 prompts the user to determine if another reminder is desired. If no further reminders are to be set, then the callflow element 36 provides a goodbye greeting.

With the standard presentation method, the list of variables in a presentation list would be:
Date
COO10
COO20
FOO30
FOO40
Time
   Using the proposed optimization method, the list would be:
Date
Time
COO10
COO20
FOO30
FOO40

In the example above, the initial system-generated values for Date and Time were FOO10 and FOO20 respectively. The illustration shows the callflow after the user has made the indicated changes. Note that the special treatment of user-generated variables would apply to variables that the user adds to the set just as it applies to those variables that the user renames.

It should be understood that the present invention can be realized in hardware, software, or a combination of hardware and software. The present invention can also be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program or application in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

1. A method of arranging user-modified variable names in a presentation list, comprising the steps of:
receiving a system request to display variables in the presentation list; and
sorting the variables by giving user-named variables greater priority over system-named variables and then sorting by a second attribute.

2. The method of claim 1, wherein the method further comprises the step of displaying the variables when a user selects the variables using a drop-down control.

3. The method of claim 1, wherein the method further comprises the step of distinguishing between a user-named variable and a system-named variable.

4. The method of claim 3, wherein the step of distinguishing is accomplished using at least one among labeling and text formatting.

5. The method of claim 1, wherein the second criteria is an alphabetical order.

6. The method of claim 1, wherein the second criteria is a chronological order.

7. A system for arranging user-modified variable names in a presentation list comprises:
a memory; and
a processor programmed to receive a system request to display the variables from the memory in the presentation list and to sort the variables by giving user-named variables greater priority over system-named variables and then sorting by a second criteria.

8. The system of claim 7, wherein the processor is further programmed to display the variables when a user selects the variables using a drop-down control.

9. The system of claim 7, wherein the processor is further programmed to distinguish between a user-named variable and a system-named variable.

10. The system of claim 9, wherein the processor distinguishes between the user-named variable and the system-named variable by using at least one among labeling and text formatting.

11. The system of claim 7, wherein the second criteria is an alphabetical order.

12. The system of claim 7, wherein the second criteria is a chronological order.

13. The system of claim 7, wherein the presentation list is at least one among a drop-down list and a list box.

14. A machine-readable storage, having stored thereon a computer program having a plurality of code sections executable by a machine for causing the machine to perform the steps of receiving a system request to display variables in a presentation list and sorting the variables by giving user named variables greater priority over system named variables and then sorting by a second attribute.

15. The machine-readable storage of claim 14, wherein the machine-readable storage is further programmed to sort by the second criteria being an alphabetical order.

16. The machine-readable storage of claim 14, wherein the machine-readable storage is further programmed to sort by the second criteria being a chronological order.
